(19) United States
(12) Patent Application Publication
(10) Pub. No.: US 2011/0060921 A1
(43) Pub. Date: Mar. 10, 2011

(54) Data Encryption Device

(76) Inventor: John Michael, London (GB)

(21) Appl. No.: 12/991,451

(22) PCT Filed: May 8, 2009
(86) PCT No.: PCT/GB09/01139

§ 371 Date: Nov. 18, 2010

(30) Foreign Application Priority Data
May 8, 2008 (GB) 0808341.2

(51) Int. Cl. G06F 21/24

(52) U.S. Cl. 713/192

(57) ABSTRACT

A device for encryption of data. The device may include a first coupling for connection to a computer, a second coupling for connection to an external data storage device, and an encryption circuit for encryption and decryption of data stored on or being transferred to the external data storage device, wherein the encryption circuit is arranged such that during encryption a decryption key is stored on the external data storage device, and such that during decryption the decryption key is retrieved from the external data storage device.

This invention relates to a device for encryption of data, and in particular to a device for coupling between a computer and an external data storage device.

Many users utilise external storage devices to increase data storage capacity and/or as a back-up solution and/or to allow data interchange between two or more personal computers. Developments in technology have made external storage devices ever more compact and convenient, and as a result their use is spreading. Typically, external storage devices are supplied in ‘plug and play’ form, i.e. needing no additional software to access the stored data. Devices can connect via a number of interfaces, such as USB, FireWire™ SATA interface. The transport of data between the home and workplace has become widespread.

Clearly, the ease of movement of data and the ease of access to data stored on these types of devices results in a major security concern. With many types of device if the device is lost or stolen then the data can be accessed on any personal computer. In the prior art, attempts have been made to address this issue.

US 2007/0033320 discloses a USB connected dongle between a computer and a memory device. The dongle encrypts and decrypts data passing between the computer and the memory device. Data on the memory device is accessible only with the use of the dongle in order to ensure that it remains secure.

Viewed from one aspect, the present invention provides a device for encryption of data comprising: a first coupling for connection to a computer, a second coupling for connection to an external data storage device, and an encryption circuit for encryption and decryption of data stored on or being transferred to the external data storage device, wherein the encryption circuit is arranged such that during encryption a decryption key is stored on the external data storage device, and such that during decryption the decryption key is retrieved from the external data storage device.

With this arrangement, the data stored on the device can be securely encrypted for security, whilst avoiding shortfalls arising from the prior art techniques. With devices such as that in US 2007/0033320 it is necessary for the exact same dongle to be used to decrypt the data. Data cannot therefore be easily transported between users without also transporting the dongle. Moreover, if the dongle used for encryption is lost, then it becomes impossible to access the data. The device of the present invention allows another corresponding device of the same type to be used for decryption, thus avoiding these issues.

In a preferred embodiment, the device comprises a security device for checking that access to the encrypted data is authorised, wherein security data generated by the security device is stored on the external data storage device along with or as a part of the decryption key. For example, the security device may comprise means for receiving and checking a code such as a password or PIN. Alternatively or in addition, the security device may comprise a biometric sensor such as a fingerprint reader.

Thus, with the use of the additional security device, access by any user with a corresponding encryption device is not permitted unless they are also able to provide the necessary code or biometrics. However, because the security data is stored on the external data storage device it is not necessary for the same encryption device to be used to encrypt and decrypt the data. A first user can send a secure encrypted storage device to a second user, and convey a security code to that second user by telephone or personally, and the second user can access the data using their own encryption device. Alternatively, where a biometric system is used, the user does not need to transport his encryption device along with the external data storage device, but instead can use another encryption device at a remote location.

In one preferred arrangement, the encryption circuit encrypts data passing between the first and second couplings. Alternatively or in addition, the encryption circuit may be arranged to encrypt data already stored on the external data storage device.

Any suitable circuit may be used for the encryption circuit, but the most preferred circuit type is an application-specific integrated circuit (ASIC), as this enables the device to be small and compact.

A preferred embodiment includes an automated back-up function, wherein the device includes a controller arranged to cause data stored on the computer to be copied to the external data storage device and encrypted. A switch may be provided to initiate the back-up function. The controller may cause all data stored on the computer to be copied to the external data storage device when the external data storage device does not contain any of the data. Alternatively, when some data from the computer is backed-up on the external data storage device the controller may cause only new data to be backed-up.

The first and second couplings may be any suitable coupling device selected from those commonly used for the connection of external data storage devices. For example, couplings adapted for use with any standard serial bus interface can be used, such as USB, FireWire™ (IEEE 1394 interface), or Serial Advanced Technology Attachment (SATA). The encryption device may be provided with a number of alternative coupling types to enable it to be compatible with different types of external storage device.

Certain preferred embodiments of the invention will now be described by way of example only and with reference to the accompanying drawings in which:

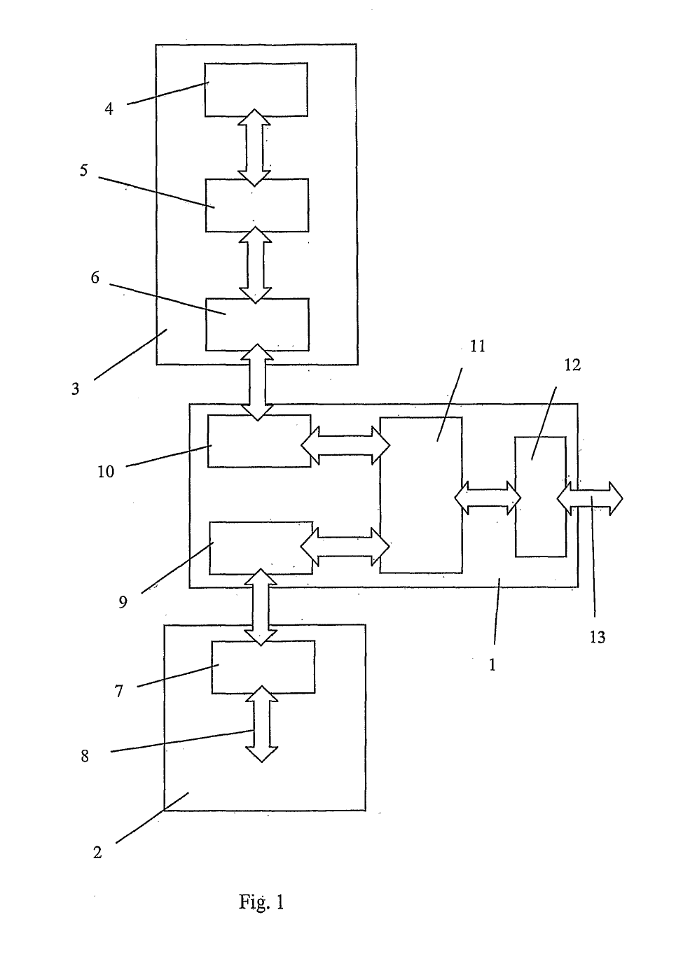

FIG. 1 shows an encryption device connected between a personal computer and an external storage device.

In FIG. 1 a preferred embodiment of an encryption device 1 is shown connected between a personal computer 2 and an external storage device 3. In the example shown, the external storage device 3 is an external hard disk drive type device, and hence includes a hard disc drive 4. The hard disc drive 4 is connected by a hard disc, drive interface 5 to a USB interface 6. The USB interface 6 enables the external storage device 3 to be coupled to a USB socket on a computer.

The personal computer 2 includes a USB interface 7, which joins to a USB socket for connection with external devices, and has a connection 8 to other parts of the personal computer 2, including the computer's internal storage (not shown).

In normal use, the external storage device 3 would connect directly to the personal computer 2, and data would be transferred directly between the two via the USB connection. The encryption device 1 is fitted in between the two, so that data passes through the encryption device 1 when it is transferred from the computer 2 to the external storage 3. The encryption device 1 includes USB interfaces 9, 10 for connection to the computer 2 and external storage 3 respectively.

The active component of the encryption device 1 is an encryption and control circuit 11 in the form of an ASIC. This circuit 11 is arranged to encrypt data passing between the computer 2 and the external storage 3. The circuit 11 is also arranged to optionally encrypt data already stored on the external data storage device 3, if required by the user. The circuit 11 has access to the external storage 3 via the USB interface 10, and is arranged to store a decryption key on the external storage 3 as part of the encryption process. During the decryption process, the device 1 looks for a decryption key on the external data storage device 3 to which it is attached. In this way, any device of this type can be used to decrypt data that is encrypted by any other device of this type, provided that additional security controls are met, as set out below.

For additional security, the device 1 comprises a security and data input device 12 for checking that access to the encrypted data is authorised and for input of data by the user via a data input interface 13. The data input by the user may include a code word or number for checking if access to the encrypted data is authorised. In this case, the security and data input device 12 includes means for receiving and checking a code such as a password or PIN. Alternatively or in addition, the security and data input device 12 may comprise a biometric sensor such as a fingerprint reader.

Security data generated by the security and data input device 12 is stored on the external data storage device 3 along with or as a part of the decryption key. This means that even with the additional security, it is still not necessary for the exact same device to be used for both the encryption and the decryption of data.

The encryption device 1 also includes an automated data back-up function. The circuit 11 is arranged to cause data stored on the computer 2 to be copied to the external data storage device 3 and encrypted in response to input from the user via the data input interface 13. Alternatively, a separate switch may be provided to initiate the back-up function. When the back-up function is first used, the circuit 11 causes all data stored on the computer 2 to be copied to the external data storage device 3 when the external data storage device 3 does not contain any of the data. During later use of the back-up function, when some data from the computer 2 is already backed-up on the external data storage device 3, the circuit 11 only backs-up new data.

I claim:

1. A device for encryption of data comprising: a first coupling for connection to a computer, a second coupling for connection to an external data storage device, and an encryption circuit for encryption and decryption of data stored on or being transferred to the external data storage device, wherein the encryption circuit is arranged such that during encryption a decryption key is stored on the external data storage device, and such that during decryption the decryption key is retrieved from the external data storage device.

2. A device for encryption of data as claimed in claim 1, comprising a security device for checking that access to the encrypted data is authorised, wherein security data generated by the security device is stored on the external data storage device along with or as a part of the decryption key.

3. A device for encryption of data as claimed in claim 2, wherein the security device comprises means for receiving and checking a code.

4. A device for encryption of data as claimed in claim 2, wherein the security device comprises a biometric sensor.

5. A device for encryption of data as claimed in claim 1, wherein the encryption circuit is arranged to encrypt data passing between the first and second couplings.

6. A device for encryption of data as claimed in claim 1, wherein the encryption circuit is arranged to encrypt data already stored on the external data storage device.

7. A device for encryption of data as claimed in claim 1, wherein the encryption circuit is an application-specific integrated circuit (ASIC).

8. A device for encryption of data as claimed in claim 1, wherein the device includes a controller arranged to cause data stored on the computer to be copied to the external data storage device and encrypted in order to provide a back-up copy of the data.

9. A device for encryption of data as claimed in claim 8, wherein a switch is provided to initiate the back-up function.

10. A device for encryption of data as claimed in claim 8, wherein the controller is arranged to cause all data stored on the computer to be copied to the external data storage device when the external data storage device does not contain any of the data, and wherein when some data from the computer is already backed-up on the external data storage device the controller causes only new data to be copied to the external data storage device.

11. A device for encryption of data as claimed in claim 1, wherein the first and second couplings are adapted for use with a standard serial bus interface, such as USB, FireWire™ (IEEE 1394 interface), or Serial Advanced Technology Attachment (SATA).

12. A device for encryption of data as claimed in claim 1, comprising a plurality of alternative coupling types to enable it to be compatible with different types of external storage device.

13. (canceled)
